(19) United States
(12) Patent Application Publication
(10) Pub. No.: US 2020/0179969 A1
(43) Pub. Date: Jun. 11, 2020

(54) UNIVERSAL JET SPRAY BAR

(71) Applicant: POMMIER -- SCEBP, Eole-En-Beauce (FR)

(72) Inventors: Frédéric LASNE, MESLAY-LE-VIDAME (FR); Nicolas POMMIER, EOLE-EN-BEAUCE (FR)

(73) Assignee: POMMIER -- SCEBP, EOLE-EN-BEAUCE (FR)

(21) Appl. No.: 16/708,705

(22) Filed: Dec. 10, 2019

(30) Foreign Application Priority Data
Dec. 10, 2018 (FR) 1872630

(51) Int. Cl. B05B 13/02; A01M 7/00; B05B 15/65

(52) U.S. Cl. CPC B05B 13/0278; B05B 15/65; A01M 7/0075

(57) ABSTRACT

A universal jet bar for the spraying or the spreading of granules or liquid conventionally including two arms articulated and each provided with a plurality of segments capable of being folded onto themselves, each segment including at least one lower profile defining a longitudinal housing open downwards and at each of its longitudinal ends, the universal jet bar receiving spraying equipment, remarkable in that it includes a plurality of premounting members capable, on the one hand, of supporting the spraying equipment and, on the other hand, of being inserted into the housing and removably rigidly connected onto the lower profile along the arms, the lower profile and housing being configured to entirely receive the premounting members and the spraying equipment.

### TECHNICAL FIELD OF THE INVENTION

The present invention relates to the general field of agriculture. It is aimed more precisely at a bar for spraying or for spreading granules or liquid.

### PRIOR ART

In the field of agriculture, it is known to treat plant cultures to combat insects, diseases or weeds, in order to guarantee a good yield of the operation.

To do this, a sprayer or spreader is conventionally used, carried or pulled by a tractor, or self-propelled, and comprising at least:
a tank containing a mixture of phytosanitary product and of water or of liquid fertilizer,
a bar comprising two articulated arms on either side of said tank, each provided with a plurality of segments capable of being folded onto themselves during the movement of the sprayer on a road, and supporting spraying or spreading nozzles, and
a pump pressurizing the mixture contained in the tank and sucking up the latter to send it to the bar and the nozzles.

One of the main disadvantages of the sprayers or spreaders is related to the manufacturing of the arms and of their segments. Indeed, the latter must satisfy the following constraints:
having a structure with a significant mechanical strength in particular for the arms and segments having a large width,
receiving the equipment necessary for the spraying or spreading (piping, nozzle holders, fastening lugs, nozzles, . . . ) and protecting it from collisions or from snagging on the plant cultures to be treated,
allowing the installation of the spray nozzles without interference with said structure and according to a regular spacing in order to guarantee homogenous spraying of the spray mixture, said spacing between the spray nozzles being variable according to the countries of use of the nozzles and/or the manufacturers of the spray nozzles.

To overcome most of these disadvantages, spray bars already exist, such as, for example, those described in the American patent applications US 2006/201075 and US 2016/263371, the arms of which are provided with segments comprising at least one first profile disposed in the lower part and defining a longitudinal housing open downwards and at each of its longitudinal ends, the first profile and the housing being configured to entirely receive the equipment necessary for the spraying or the spreading. It is understood that with such a housing freeing a space over the entire length of the modular element, the spray nozzles can be installed in said housing without interference with the structure of said modular element, regardless of the spacing between the nozzles.

However, this type of bar, which is very practical, still has a disadvantage related to the installation of said equipment necessary for the spraying or the spreading.

Indeed, to install this equipment on these bars, conventionally first of all the mechanical and hydraulic part is assembled, then an operator fastens, one by one, the pipes, sheaths, nozzles or spouts, electrical wires or pneumatic capillary tubes onto the structure of said bars by fastening members such as, for example, clamp holders screwed onto fastening lugs for the rigid ducts and plastic collars for the flexible pipes, wires and capillary tubes. This operation is long and tedious since it is performed through structural elements of the bars. Moreover, this operation must be performed necessarily at the end of the operations of manufacturing of the structure of the bars, which increases by as much the manufacturing time of the latter.

### DESCRIPTION OF THE INVENTION

The goal of the present invention is to propose a bar for spraying or for spreading granules or liquid that is easy and fast to manufacture while allowing in particular a mounting of the spraying elements carried out independently of the manufacturing of the structure of the bar then a simple and fast assembly of the final assembly, while guaranteeing a significant mechanical strength regardless of the their width and while allowing the installation of spray nozzles without interference with said structure, regardless of their spacing.

According to the invention, a universal jet bar for the spraying or the spreading of granules or liquid is therefore proposed, conventionally comprising two arms articulated and each provided with a plurality of segments capable of being folded onto themselves, each segment comprising at least one lower profile defining a longitudinal housing open downwards and at each of its longitudinal ends, said universal jet bar receiving spraying equipment being remarkable in that it comprises a plurality of premounting members capable, on the one hand, of supporting said spraying equipment and, on the other hand, of being inserted into the housing and removably rigidly connected onto the lower profile along said arms, said lower profile and housing being configured to entirely receive the premounting members and the spraying equipment.

The lower profile advantageously has a transverse cross-section in the overall shape of a C pivoted by 90° and comprises a substantially horizontal core, two flanges coming from the longitudinal edges of said core and extending towards the bottom of said lower profile, and two lips each coming from the lower longitudinal edges of said flanges and extending substantially horizontally towards the inside of said flanges while facing each other.

According to a preferred embodiment, each premounting member has a transverse cross-section in the overall shape of an inverted U and comprises a substantially horizontal core, two flanges coming from the longitudinal edges of said core and extending towards the bottom of the premounting member, each flange being elastically deformable and comprising, on its outer face near its free longitudinal edge, a heel disposed protruding towards the outside of said premounting member and comprising at least one flat lower face, and each premounting member is dimensioned to be clipped inside the lower profile between its flanges.

The heel of each flange of the premounting members advantageously comprises an inclined face acting as a ramp and allowing a progressive tightening of said flanges during the clipping of said premounting members in the associated lower profile.

Each premounting member preferably has a transverse cross-section in the overall shape of a flared inverted U.

The core and the flanges of each premounting member are advantageously assembled to each other in a removable manner to allow to adapt the width of said premounting member.

The core and the flanges of each premounting member are preferably assembled to each other by a sliding link of the dovetail type.

According to an alternative realization, each premounting member has a transverse cross-section in the overall shape of a flared inverted U and comprises a substantially horizontal core, two flanges coming from the longitudinal edges of said core and extending towards the bottom of the premounting member, each of the flanges of the premounting member being elastically deformable and each premounting member being dimensioned to be clipped inside the lower profile between its flanges.

Advantageously, each flange comprises a first flat portion coming from the associated longitudinal edge of the core and extending towards the outside of the premounting member, a second flat portion coming from the free longitudinal edge of said first portion and extending towards the inside of the premounting member and a third flat portion coming from the free longitudinal edge of said second portion and extending generally perpendicularly to said core, the zone of junction between the first and second portions acts as a heel.

Preferably, the universal jet bar according to the invention comprises complementary fastening means ensuring the immobilization of the premounting members once the latter have been clipped inside the associated lower profile.

### BRIEF DESCRIPTION OF THE DRAWINGS

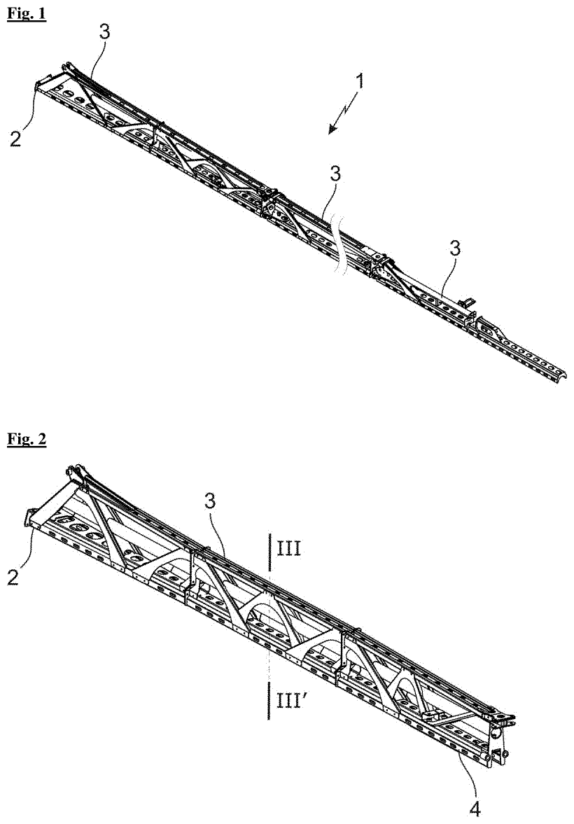

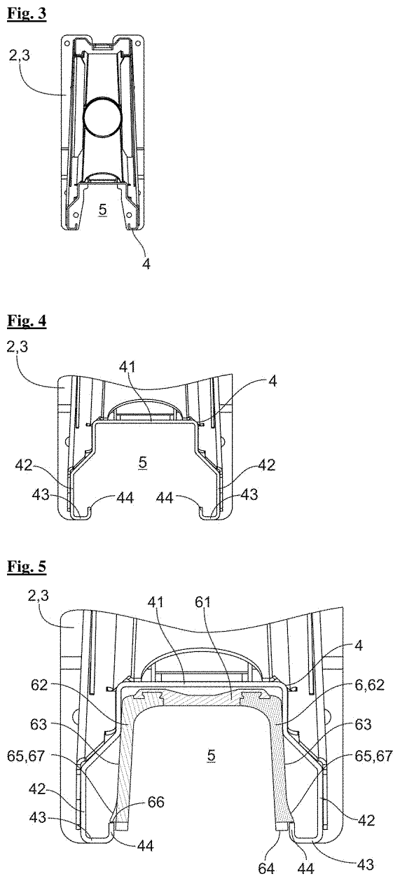

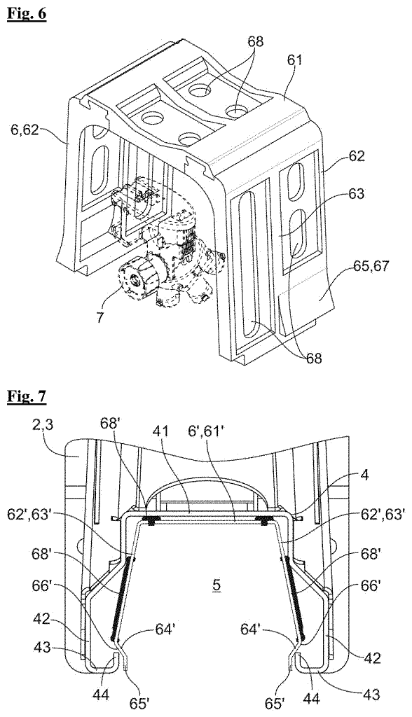

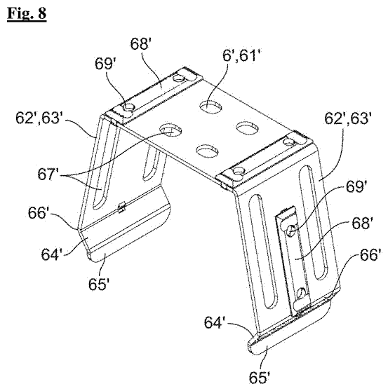

Other advantages and features will be clearer from the following description of a mode of execution of the invention in reference to the appended drawings in which:

[FIG. 1] is a perspective view of an arm of a universal jet arm according to the invention,

[FIG. 2] is an enlarged perspective view of the segment of the arm of FIG. 1,

[FIG. 3] is an enlarged vertical cross-section of the segment of FIG. 2 along the axis III-III′,

[FIG. 4] is an enlarged detailed view of FIG. 3,

[FIG. 5] is an enlarged detailed view of FIG. 3 with a premounting member,

[FIG. 6] is an enlarged perspective view of the premounting member of FIG. 5 in which a part of the spraying equipment shown by a thin dotted line in particular a spray nozzle is installed,

[FIG. 7] is an enlarged detailed of FIG. 3 with an alternative realization of the premounting member,

[FIG. 8] is an enlarged perspective view of the premounting member of FIG. 7.

### BEST WAY TO IMPLEMENT THE TECHNICAL INVENTION

In reference to FIGS. 1 to 4, the universal jet bar 1 for spraying or for spreading granules or liquid according to the invention, hereinafter called universal jet bar 1, conventionally comprises two articulated arms 2, each provided with a plurality of segments 3 capable of being folded onto themselves.

Each segment 3 comprises at least one lower profile 4 defining a longitudinal housing 5 open downwards and at each of its longitudinal ends.

Said lower profile 4 preferably has a transverse cross-section in the overall shape of a C pivoted by 90° and comprises a substantially horizontal core 41, two flanges 42 coming from the longitudinal edges of said core 41 and extending towards the bottom of the segment 3, and two lips 43 each coming from the lower longitudinal edges of said flanges 42 and extending substantially horizontally towards the inside of said flanges 42 while facing each other (cf. FIG. 4).

In the example of realization shown, the lips 43 advantageously have, for reasons of mechanical strength, a vertical cross-section in the shape of an L and each comprise a fold 44 coming from their free longitudinal edge and extending towards the top of the segment 3.

However, it is understood that the lips 43 can have a vertical cross-section of any other shape without going beyond the context of the present invention.

In reference to FIGS. 5 and 6, the universal jet bar 1 further comprises a plurality of premounting members 6 capable, on the one hand, of supporting the spraying equipment 7 and, on the other hand, of being inserted into the housing 5 and removably rigidly connected onto the lower profile 4 along the arm 2 of the universal jet bar 1.

Here, “spraying equipment 7” designates the equipment installed on the universal jet bar 1 and necessary for the spraying or for the spreading of granules or liquid, said equipment comprising in particular piping, sheaths, electrical wires or pneumatic capillary tubes, nozzles or spouts, nozzle holders, or fastening lugs.

The lower profile 4, the housing 5 and the premounting members 6 are configured to entirely receive the premounting members 6 and the spraying equipment 7.

Here, “entirely receive” designates the fact that once installed in the housing 5, the premounting members 6 and spraying equipment 7 assembly does not protrude past the first profile 4, in particular the lower edge of its flanges 42.

With this configuration, it is understood that once installed in said housing 5, the premounting members 6 and spraying equipment 7 assembly is perfectly protected from collisions or from snagging on the plant cultures to be treated, by the first profile 4 and in particular by its flanges 42 and its lips 43.

It is understood that this configuration of the universal jet bar 1 according to the invention allows a fast and adaptive mounting of the spraying equipment 7.

Indeed, an operator can, in advance and outside of the structure of the universal jet bar 1, assemble together in the form of a bundle the various elements of the spraying equipment 7, regardless of the spacing of the nozzles, then insert said bundle into the housing 5 of the lower profile 4 of each segment 3 of each arm 2 of the universal jet bar 1, once the manufacturing of the latter has been completely finished, and finally removably rigidly connect each premounting member 6 onto the associated lower profile 4 without a risk of interference with the structure of the universal jet bar 1.

For economic and practical reasons, it is understood that the premounting members 6 are at least two in number and distributed at points along each segment 3 of each arm 2 of the universal jet bar 1, to guarantee the perfect retention of the bundle of the various elements of the spraying equipment 7 inside the housing 5 of the lower profile 4 of each segment 3.

It is understood that the assembly and the rigid connection of the bundle of elements of the spraying equipment 7 are thus carried out in a reduced number of operations. Moreover, it is understood that the assembly of said bundle can advantageously be done in parallel and/or concurrently to the manufacturing of the structure of the universal jet bar 1, by at least partly automating all or a part of these operations, which allows to significantly reduce the cost of production of the universal jet bar 1 according to the invention.

Moreover, it is understood that the premounting members 6 are only dimensioned to support the spraying equipment 7 and in no case participate in the mechanical strength of the structure of the universal jet bar 1, since the premounting members 6 do not have a predetermined position and the premounting members 6 and spraying equipment 7 assembly is installed in the housing 5 of the lower profile 4 of each segment 3 of each arm 2 of the universal jet bar 1, once the manufacturing of the latter has been completely finished.

According to an advantageous embodiment shown, each premounting member 6 has a transverse cross-section in the overall shape of an inverted U and comprises a substantially horizontal core 61, two flanges 62 coming from the longitudinal edges of said core 61 and extending towards the bottom of the premounting member 6.

The core 61 and the flanges 62 are advantageously assembled to each other in a removable manner to allow to adapt the width of the premounting member 6 to the width of the lower profile 4 of the segments 3 of the arm 2 of the universal jet bar 1 according to the invention by installing a more or less wide core 61.

Thus, the core 61 and the flanges 62 can be assembled to each other, for example, by a sliding link of the dovetail type, as shown in FIGS. 5 and 6.

Each flange 62 of the premounting member 6 is elastically deformable and comprises, on its outer face 63 near its free longitudinal edge 64, a heel 65 disposed protruding towards the outside of said premounting member 6. Said heel 65 comprises at least one substantially horizontal flat lower face 66, and advantageously an inclined face 67.

Each premounting member 6 is dimensioned to be clipped inside the lower profile 4 of each segment 3 between its flanges 42.

Here, “clipped inside the lower profile 4” means the fact that, when the premounting member 6 is installed inside said associated lower profile 4, the upper face of its flange 61 bears against the lower face of the flange 41 of said lower profile 4, and the lower face 66 of each heel 65 and the part of the outer face 63 of each of its flanges 62 located under said heel 65 bear against the associated lip 43 of said lower profile 4 to maintain in position said premounting member 6, the bearing against said lip 43 being ensured by the elasticity of the flanges 62 of the premounting member 6 which creates a stress tending to move apart the free longitudinal edges 64 of the latter.

For this, it is understood that the premounting member 6 is dimensioned for its overall width between its heels 65 to be strictly greater than the width between the lips 43 of the associated lower profile 4.

Moreover, it is understood that the inclined face 67 of the heels 65 of each premounting member 6 acts as a ramp and allows a progressive tightening of the flanges 62 of the latter during its clipping in the associated lower profile 4.

Finally, in reference to FIG. 6, each premounting member 6 comprises, obviously, a plurality of through-holes 68 arranged on its core 61 and/or on its flanges 62, said orifices 68 allowing the fastening of the various elements of the spraying equipment 7 onto said premounting member 6 and the immobilization of the latter once clipped inside the associated lower profile 4 by complementary fastening means such as, for example, bolts or rivets. The complementary fastening means can also be glue.

FIGS. 7 and 8 show an alternative realization of the premounting members 6′ similar to the premounting members 6 described above and capable, on the one hand, of supporting the spraying equipment 7 and, on the other hand, of being inserted into the housing 5 and removably rigidly connected onto the lower profile 4 along the arm 2 of the universal jet bar 1.

Each premounting member 6′ has a transverse cross-section in the overall shape of a flared inverted U and comprises a substantially horizontal core 61′, two flanges 62′ coming from the longitudinal edges of said core 61′ and extending towards the bottom of the premounting member 6′, each of the flanges 62′ of the premounting member 6′ being elastically deformable.

Each flange 62′ comprises a first flat portion 63′ coming from the associated longitudinal edge of the core 61′ and extending towards the outside of the premounting member 6′, a second flat portion 64′ coming from the free longitudinal edge of said first portion 61′ and extending towards the inside of the premounting member 6′ and a third flat portion 65′ coming from the free longitudinal edge of said second portion 61′ and extending generally perpendicularly to said core 61′. With this configuration and an adapted dimensioning of the premounting member 6′, the zone of junction between the first and second portions 63′,64′ acts as a heel 66′ and allows to clip said premounting member 6′ inside the lower profile 4 of each segment 3 between its flanges 42 (cf. FIG. 7).

Here, “clip inside the lower profile 4” means the fact that, when the premounting member 6′ is installed inside said associated lower profile 4, the upper face of its flange 61′ bears against the lower face of the flange 41 of said lower profile 4, and the lower face of each second portion 64′ bears against the associated lip 43 of said lower profile 4 to maintain in position said premounting member 6′, the bearing against said lip 43 being ensured by the elasticity of the flanges 62′ of the premounting member 6′ which creates a stress tending to move apart the free ends of the latter.

For this, it is understood that the premounting member 6′ is dimensioned for its overall width between the heels 66′ to be strictly greater than the width between the lips 43 of the associated lower profile 4.

Moreover, it is understood that the inclined face of the first portion 63′ of the flanges 62′ of each premounting member 6′ acts as a ramp and allows a progressive tightening of said flanges 62′ of the latter during its clipping in the associated lower profile 4.

Moreover, in reference to FIG. 8, each premounting member 6′ comprises, obviously, a plurality of through-holes 67′ arranged on its core 61′ and/or on its flanges 62′, said orifices 67′ allowing the fastening of the various elements of the spraying equipment 7 onto said premounting member 6′ and the immobilization of the latter once clipped inside the associated lower profile 4 by complementary fastening means such as, for example, bolts or rivets. The complementary fastening means can also be glue.

Finally, for the same reasons, each premounting member 6′ can also comprise reinforcing plates 68′ provided with orifice 69′, advantageously inner threads, fastened onto its core 61′ and/or onto its flanges 62′, these reinforcing plates 68′ being advantageously disposed on the faces of said core 61′ and/or flanges 62′ located outside of said premounting member 6′ to free up as much space as possible inside of the latter. In this latter hypothesis, when the premounting member 6′ is clipped inside said associated lower profile 4, the upper face of the reinforcing plates 68′ fastened onto its flange 61′ thus bears against the lower face of the flange 41 of said lower profile 4.

### INDUSTRIAL APPLICABILITY

The universal jet bar 1 according to the invention applies to the spraying or the spreading of granules or liquid regardless of the spacing between the spraying or spreading nozzles 7.

Finally, it goes without saying that universal jet bars 1 according to the invention that have just been described are only specific illustrations, in no case limiting to the invention.

1-10. (canceled)

11. A universal jet bar for the spraying or the spreading of granules or liquid, conventionally comprising:
two arms articulated and each provided with a plurality of segments capable of being folded onto themselves, each segment further comprising at least one lower profile defining a longitudinal housing open downwards and at each of its longitudinal ends, said universal jet bar receiving spraying equipment, wherein it comprises a plurality of premounting members capable, on the one hand, of supporting said spraying equipment and, on the other hand, of being inserted into the housing and removably rigidly connected onto the lower profile along said arms, said lower profile and housing being configured to entirely receive the premounting members and the spraying equipment.

12. The universal jet bar according to claim 11, wherein the lower profile has a transverse cross-section in the overall shape of a C pivoted by 90° and comprises a substantially horizontal core, two flanges coming from the longitudinal edges of said core and extending towards the bottom of said lower profile, and two lips each coming from the lower longitudinal edges of said flanges and extending substantially horizontally towards the inside of said flanges while facing each other.

13. The universal jet bar according to claim 12, wherein each premounting member has a transverse cross-section in the overall shape of an inverted U and comprises a substantially horizontal core, two flanges coming from the longitudinal edges of said core and extending towards the bottom of the premounting member, each flange being elastically deformable and comprising, on its outer face near its free longitudinal edge, a heel disposed protruding towards the outside of said premounting member and comprising at least one flat lower face and in that each premounting member is dimensioned to be clipped inside the lower profile between its flanges.

14. The universal jet bar according to claim 13, wherein the heel of each flange of the premounting members comprises an inclined face acting as a ramp and allowing a progressive tightening of said flanges during the clipping of said premounting members in the associated lower profile.

15. The universal jet bar according to claim 13, wherein each premounting member has a transverse cross-section in the overall shape of a flared inverted U.

16. The universal jet bar according to claims 13, wherein the core and the flanges of each premounting member are assembled to each other in a removable manner to allow to adapt the width of said premounting member.

17. The universal jet bar according to claim 16, wherein the core and the flanges of each premounting member are assembled to each other by a sliding link of the dovetail type.

18. The universal jet bar according to claim 12, wherein each premounting member has a transverse cross-section in the overall shape of a flared inverted U and comprises a substantially horizontal core, two flanges coming from the longitudinal edges of said core and extending towards the bottom of the premounting member, each of the flanges of the premounting member being elastically deformable and in that each premounting member is dimensioned to be clipped inside the lower profile between its flanges.

19. The universal jet bar according to claim 18, wherein each flange comprises a first flat portion coming from the associated longitudinal edge of the core and extending towards the outside of the premounting member, a second flat portion coming from the free longitudinal edge of said first portion and extending towards the inside of the premounting member and a third flat portion coming from the free longitudinal edge of said second portion and extending generally perpendicularly to said core, the zone of junction between the first and second portions acts as a heel.

20. The universal jet bar according to claim 13, wherein it comprises complementary fastening means ensuring the immobilization of the premounting members once the latter have been clipped inside the associated lower profile.
